(19) United States
(12) Patent Application Publication
(10) Pub. No.: US 2021/0403030 A1
(43) Pub. Date: Dec. 30, 2021

(54) LASER BASED COMPUTER CONTROLLED TOPOGRAPHIC PROFILER

(71) Applicant: Waterblasting, LLC, Stuart, FL (US)

(72) Inventors: James Crocker, Stuart, FL (US); Stephen Carroll, Stuart, FL (US)

(21) Appl. No.: 17/357,315

(22) Filed: Jun. 24, 2021

Related U.S. Application Data
(60) Provisional application No. 63/043,620, filed on Jun. 24, 2020.

(51) Int. Cl. B60W 60/00; G06K 9/00

(52) U.S. Cl. CPC B60W 60/001; B60W 2552/53; B60W 2420/42; G06K 9/00798

(57) ABSTRACT

A computer controlled laser based profiling system for accurate equipment positioning. In one embodiment the profiler is used in combination with a vehicle automated guidance system for guiding a vehicle and equipment secured to a vehicle for removing of road markings. The computer controlled profiler detects the position of one or more grinding, grooving, rumbling heads in the X, Y and Z position. A controller and one or more actuators are manipulated in response to ground markings visible in the field of the laser.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/043,620 entitled “LASER BASED COMPUTER CONTROLLED TOPOGRAPHIC PROFILER”, filed Jun. 24, 2020. The contents of which is incorporated herein by reference.

### FIELD OF INVENTION

The present invention generally relates to mobile vehicles and, more particularly, to vehicles used in water blasting, grinding, grooving, rumbling and striping using a computer controlled laser based profiling system for accurate equipment positioning.

### BACKGROUND INFORMATION

Road surface markings provide guidance information to both drivers and pedestrians. Markings include, for instance, yellow cautions, white edge of road lines, turn signal lines, reflective markers, and so forth. Road surface markings vary in form but are all designed to improve safety for those traveling over the roadways.

Marking devices may also be raised or recessed into the road surface, and can either be reflective or non-reflective. Most mechanical road surface markings are permanent; however, some are movable. Botts' dots are generally used to mark the edges of traffic lanes providing tactile and auditory feedback to vehicle drivers who cross them. Rumble strips are employed and typically consist of a series of troughs that are ground into the asphalt roadway. Rumble strips can be use to warn of hazards of not staying within a specific lane and can create a strong vibration and sound to alert vehicle drivers. Reflective markers are used as travel lane dividers to mark the median or to mark exit slip-roads. By incorporating a raised retro-reflective element, reflective markers are more visible at night and in inclement weather than standard road marking lines.

Non-mechanical markings include, but are not limited to paint, thermo-set, tape, and thermoplastic pavement markings. Paint, which sometimes includes additives such as retro-reflective glass beads, is generally used to mark travel lanes, spaces in parking lots or special purpose spaces for disabled parking, loading zones, or time-restricted parking areas. Paint is a low-cost application.

Thermoplastic has become one of the most common types of road surface markings based on its balance between cost and performance longevity. Thermoplastic is durable, easy to apply, and can be made to be reflective. The longevity of thermoplastic makes it a very cost effective traffic delineation solution. The use of thermoplastics over paints has increased mainly due to the performance benefits of increased durability and retro-reflectivity. Furthermore, municipalities can budget for a thermoplastic replacement marking every few years instead of having to budget for paint striping every year or less.

When surface markings are to be replaced and renewed, methods of surface marking removal may be a grinder head or water blaster, or combination thereof. A grinder head is capable of deep impact cuts into the road surface by forming rumbler strips, or minimal surface impact for removal of thermoplastic markings without damaging the road surface. In other instances the removal of the thermoplastic material may use water blasting, or a combination grinder/water blaster vehicle. The vehicles may be separate wherein one vehicle is used to grind away a majority of the stripe and another vehicle is uses ultra high pressure fluid to remove the remainder of the strip. In other instances a grinder may be used to remove stripping and establish an indentation for receipt of replacement stripping. In all such instances a need exists to place the grinder head at a precise position that takes into account any slope in the roadway and confirms that the grinder has performed as placed.

In order to guide a vehicle having a grinder head, prior art utilizes a trained operator who may be assisted by a video camera to steer the vehicle to control the grinder head along a proper trajectory. This often requires significant experience and talent to efficiently remove the markings in a single pass without damaging the roadway.

What is needed in the art is a laser based computer controlled topographic profiler for positioning and controlling grinder and water blaster heads to provide precise detection of line thickness and depth.

### SUMMARY OF THE INVENTION

Briefly, one embodiment of the invention involves a laser based computer controlled topographic profiler for use in combination with a vehicle automated guidance system for guiding a vehicle and equipment secured to a vehicle for removing of road markings. The system includes a carriage mounted laser, a controller and one or more actuators that are manipulated in response to ground markings visible in the laser field. This allows the vehicle or the equipment secured to the vehicle to be positioned in real-time as the vehicle progresses. A controller allows an operator to control grinder heads individually to allow precise adjustment based upon an operators visual inspection. The computer controlled profiler detects the position of one or more grinding, grooving, rumbling heads in the X, Y and Z position. The grinding head takes feedback from vertical and horizontal linear actuators that have an internal encoder so as instruct the computer where the cylinder is positioned. A rotary encoder sits against a vehicle tire to detect motion.

An objective of the invention is to disclose laser based computer controlled topographic profiler for use in detecting line thickness and grooving depth. The laser is capable of measuring the internal dimensions of a groove or rumble stripe to very what was intended to be cut has been actually cut.

Still another objective of the invention is to provide grinder vehicle having up to two heads on each side of the vehicle facilitated by guidance from laser based computer controlled topographic profiler for use in combination with a self-guided road marking system capable of steering a piece of equipment secured to a vehicle to follow a preexisting road marking.

Still another objective of the invention is to provide a laser based computer controlled topographic profiler for precise depth control of a grinder using a cylinder technology integrated into the grinder head carriage.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a left front perspective view of a grinder head having a laser based computer controlled topographic profiler illustrated before and after the grinder head;

FIG. 2 is a front view thereof;

FIG. 3 is a top view thereof;

FIG. 4 is a right side view thereof

FIG. 5 is a left front perspective view of a grinder head having a laser based computer controlled topographic profiler illustrated before and after the grinder head;

FIG. 6 is a front view thereof;

FIG. 7 is a top view thereof;

FIG. 8 is a left cross sectional view thereof.

### DETAILED DESCRIPTION

While the present invention is susceptible of embodiment in various forms, there is shown in the drawings and will hereinafter be described a presently preferred and alternative embodiments with the understanding that the present disclosure is to be considered an exemplification of the invention and is not intended to limit the invention to the specific embodiments illustrated. It is noted that the laser based computer controlled topographic profiler of the instant invention can be used grinders, water blasting heads and vehicles that apply stripping by providing precise measurements of road profile, before and after cutting or before and after the application of stripping. For ease of illustration, the following illustrations depict the placement of the laser on various grinder heads, but the invention is not limited to use only with grinder heads.

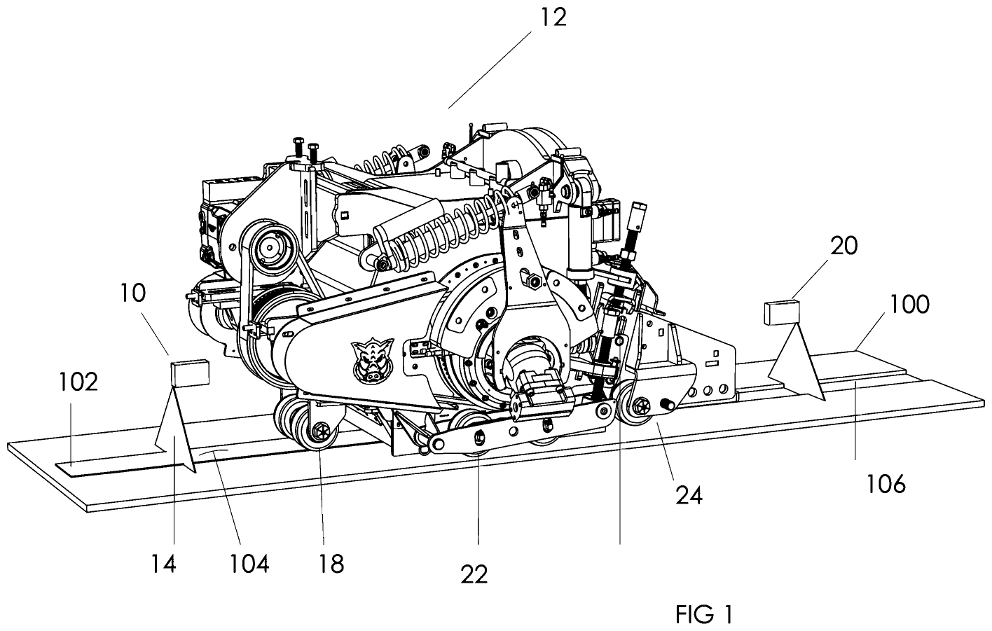

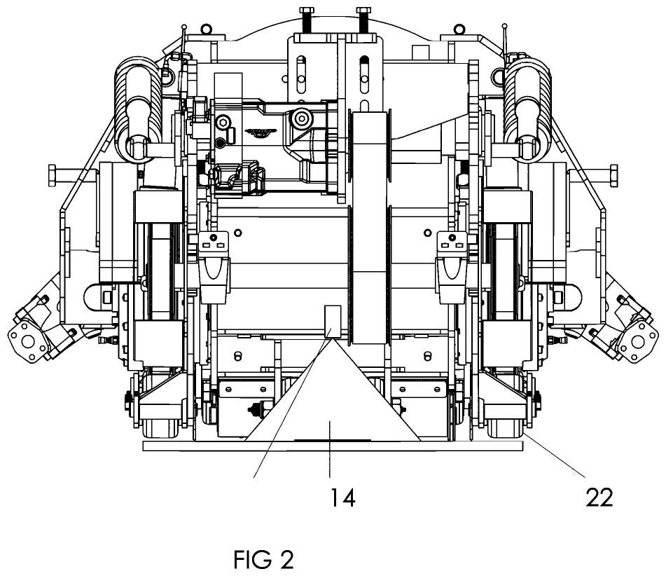

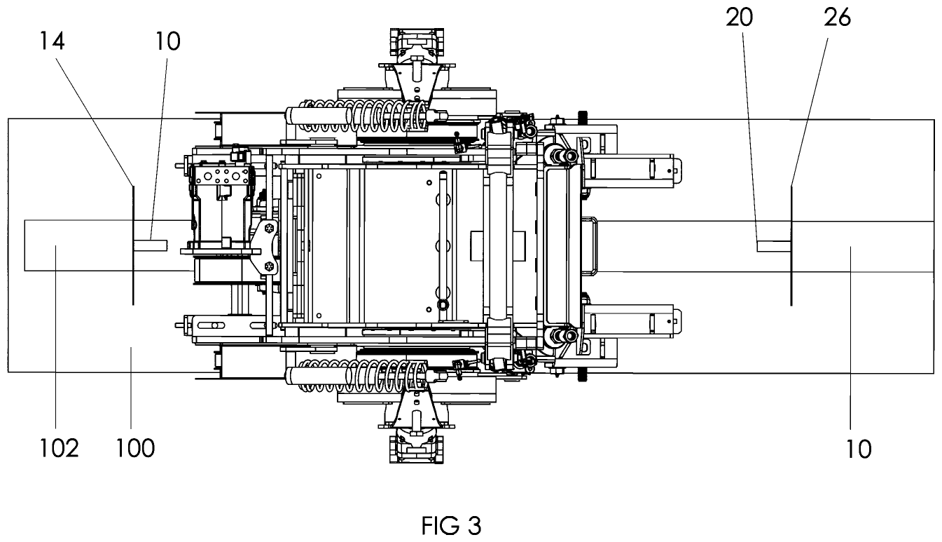

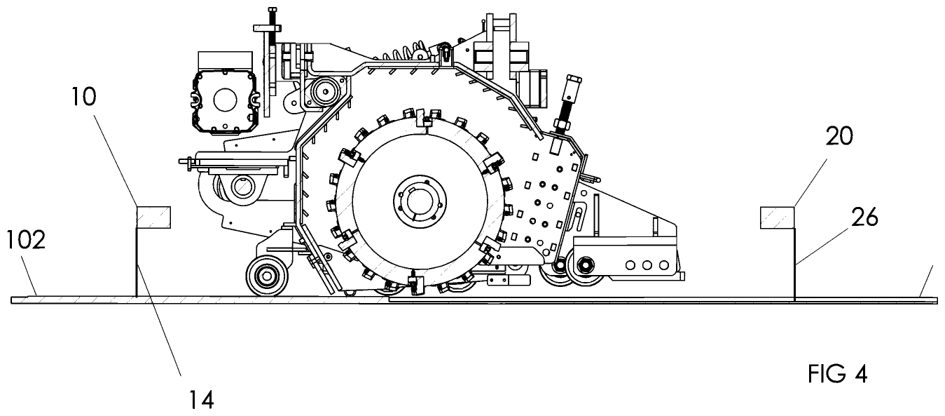

Referring to FIGS. 1-4 depicted is a road surface 100 wherein a strip 102 is to be removed and recessed strip formed. A first laser 10 is carriage mounted at the front of a grinder head 12 for the precise measurement of the road surface 100 and thickness of the existing strip 102. The beam 14 on the laser 10 having a width capable of determining the differential between the road surface 100 and the top surface 104 of the strip 102. The laser beam capable of detecting and precisely measuring the thermoplastic edgeline, skips, skip solids or doubles.

A frontal laser 10 depicting a road having a laser based computer controlled topographic profiler. By way of example, the space in between a skip is managed by maintaining support wheels 18, 22 and 24 in contact with the road surface 100 at all times and by use of the actuator linked to the control arm, a cylinder pushing down on the control arm allows the wheels to be adjusted allowing the grinder to articulate over the surface. The position of the piston is the precise position of the wheels in relation to the grinder.

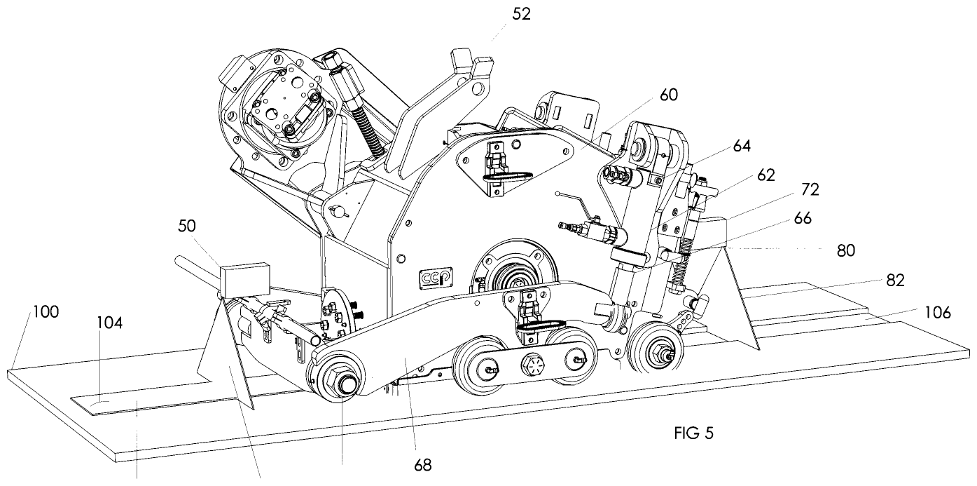

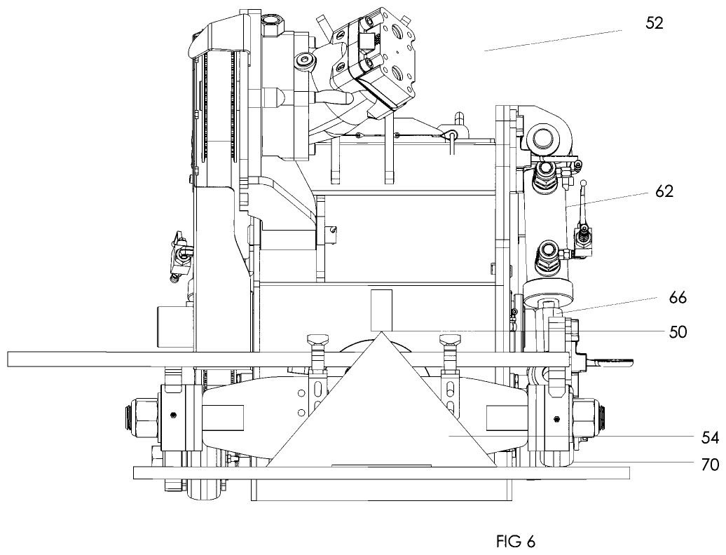

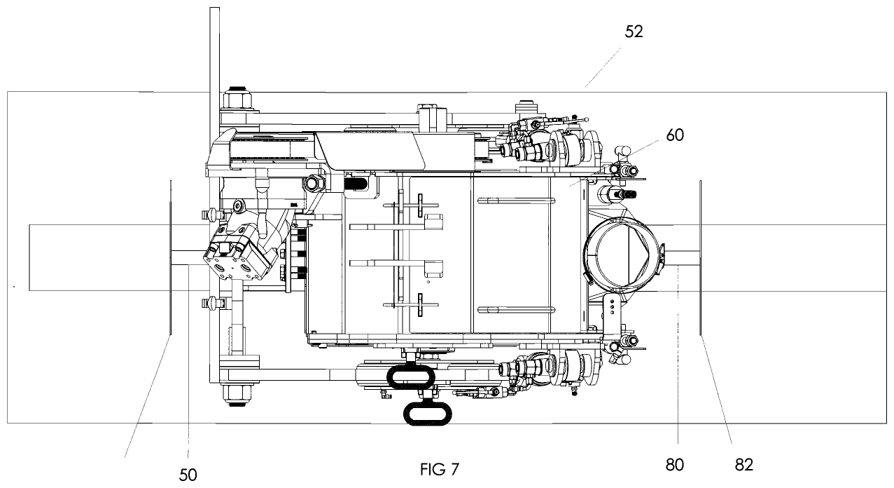

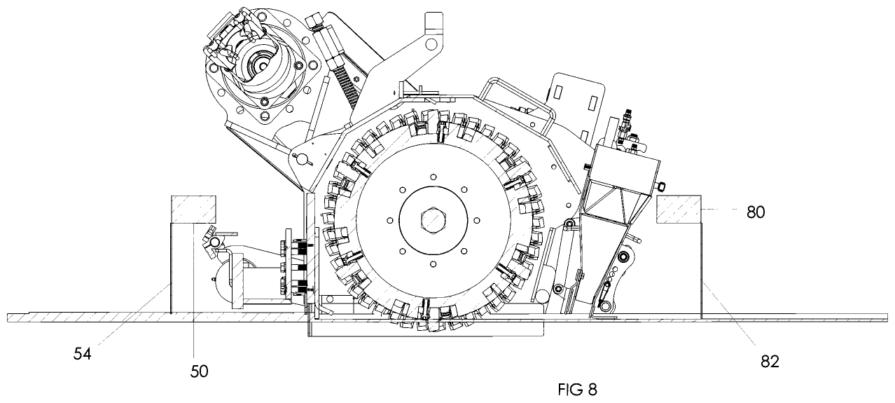

Referring to FIGS. 5-8 depicted is a road surface 100 wherein a strip 102 is to be removed and a recessed groove is to be allowed or replaced with a new strip. In this example a first laser 50 is carriage mounted at the front of a grinder head 52 for the precise measurement of the road surface 100 and thickness of the existing strip 102. The beam 54 on the laser having a width capable of determining the differential between the road surface 100 and the top surface 104 of the strip 102. The laser beam 54 is capable of detecting and precisely measuring the thermoplastic edgeline, skips, skip solids or doubles.

The grinder head 52 is illustrated by a frame 60 having a smart cylinder 62 that comprises a linear position sensor and actuators 64 which are mechanically linked. When a cylinder piston 66 is moved the sensor measures the location of the piston 66 to provide precise control of a control arm 68 having a front section with wheels 70 for making precise positioning over the roadway possible. Incorporating a smart cylinder 62 into the grinding head makes the precise positioning possible. The use of a screw actuator 72 can provide a precise ending point by continually verifying at 48 hertz to determine rotation, in this example the X rotation. For example, a screw actuator, even in that particular servo will know it is turning in the X rotation but a screw actuator will stop movement. By dithering back and forth at 499 to 501 thousandths, at 48 times a second, the screw actuator can be positioned at 500 thousandths.

By way of example, the space in between a skip is managed by maintaining support wheels 70 in contact with the payment surface at all times and by use of the actuator 64 linked to the control arm 68. By the cylinder 66 pushing down on the control arm 68 the wheels 70 are adjusted allowing the grinder to articulate over the surface. The cylinder has no other linkage, the position of the piston 66 within the cylinder 62 is the precise position of the wheels 70 in relation to the grinder.

The second laser 80 has a beam 82 width that encompassing the groove 106 with the computer controller determining if the grinder has properly removed the material in accordance with programmed instructions.

The laser based computer controlled Topographic profiler of the instant invention comprises: a carriage mounted laser constructed and arranged to measure a thickness of a existing strip coupled to a road surface, said laser coupled to a programmable computer for determining the differential spacing between said road surface and the top surface of said strip, differential spacing is managed by maintaining support wheels in contact with said road surface by use of an actuator linked to a control arm, a cylinder coupled to said control arm operates in conjunction with said wheels to position said carriage at a predetermined distance above said road surface, said cylinder including a piston having a sensor providing data input to said computer for determining the position of said piston for movement of said control arm for to provide precise positioning of said carriage or said roadway. A screw actuator having a servo is used for determining a precise ending point by continually verifying rotation. The servo operates at 48 hertz to determine rotation, said servo dithering back and forth at 499 to 501 thousandths, at 48 times a second, wherein said screw actuator can be positioned at 500 thousandths.

The laser is capable of detecting and precisely measuring a thermoplastic edgeline, skips, skip solids or doubles. A space in between a skip is managed by maintaining support wheels in contact with said road surface by use of an actuator linked to a control arm, a cylinder coupled to said control arm operates in conjunction with said wheels to position a carriage at a predetermined distance above said road surface.

A second laser operatively associated with the computer for determining if said grinder has properly removed the material in accordance with programmed instructions. The laser is constructed and arranged to detect the position of one or more grinding, grooving, rumbling heads in the X, Y and Z position.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objects and obtain the ends and advantages mentioned, as well as those inherent therein. Any compounds, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A laser based computer controlled Topographic profiler comprising: a carriage mounted laser constructed and arranged to measure a thickness of a existing strip coupled to a road surface, said laser coupled to a programmable computer for determining the differential spacing between said road surface and the top surface of said strip, differential spacing is managed by maintaining support wheels in contact with said road surface by use of an actuator linked to a control arm, a cylinder coupled to said control arm operates in conjunction with said wheels to position said carriage at a predetermined distance above said road surface, said cylinder including a piston having a sensor providing data input to said computer for determining the position of said piston for movement of said control arm for to provide precise positioning of said carriage or said roadway.

2. The laser based computer controlled Topographic profiler according to claim 1 including a screw actuator with a servo for determining a precise ending point by continually verifying rotation.

3. The laser based computer controlled Topographic profiler according to claim 1 wherein said servo operates at 48 hertz to determine rotation, said servo dithering back and forth at 499 to 501 thousandths, at 48 times a second, wherein said screw actuator can be positioned at 500 thousandths.

4. The laser based computer controlled Topographic profiler according to claim 1 wherein said laser is capable of detecting and precisely measuring a thermoplastic edgeline, skips, skip solids or doubles.

5. The laser based computer controlled Topographic profiler according to claim 4 wherein a space in between a skip is managed by maintaining support wheels in contact with said road surface by use of an actuator linked to a control arm, a cylinder coupled to said control arm operates in conjunction with said wheels to position a carriage at a predetermined distance above said road surface.

6. The laser based computer controlled Topographic profiler according to claim 1 wherein said carriage is supporting a grinder housing.

7. The laser based computer controlled Topographic profiler according to claim 1 including a second laser operatively associated with said computer for determining if said grinder has properly removed the material in accordance with programmed instructions.

8. The laser based computer controlled Topographic profiler according to claim 1 wherein said laser is constructed and arranged to detect the position of one or more grinding, grooving, rumbling heads in the X, Y and Z position.

9. The laser based computer controlled Topographic profiler according to claim 1 wherein one or more actuators are manipulated in response to ground markings visible in the field of said laser.
